(19) United States
(12) Patent Application Publication
(10) Pub. No.: US 2018/0152074 A1
(43) Pub. Date: May 31, 2018

(54) STATOR

(71) Applicant: Coreteq Systems Ltd., Lyon Way Frimley, Surrey (GB)

(72) Inventors: Philip HEAD, Virginia Water, Surrey (GB); Hassan MANSIR, Maidenhead (GB)

(21) Appl. No.: 15/569,915

(22) PCT Filed: Apr. 28, 2016
(86) PCT No.: PCT/GB2016/051222

§ 371 Date: Oct. 27, 2017

(30) Foreign Application Priority Data
Apr. 28, 2015 (GB) 1507258.0

(51) Int. Cl. H02K 5/132; H02K 1/16; H02K 3/34; H02K 3/44; H02K 5/16

(52) U.S. Cl. CPC H02K 5/132; H02K 1/16; E21B 4/04; H02K 3/44; H02K 5/16; H02K 3/345

(57) ABSTRACT

A stacked stator comprises a plurality of modular components including modular stator elements canned in a cylindrical wall each modular stator being substantially equal in length to a bearing span for the rotor a thin wall longitudinal tube which seals the rotor cavity wherein each modular component abuts the modular component to seal the rotor cavity. The modular components include modular bearing supports. Longitudinal winding slots are provided, having insulating slot liners, which may be extruded.

### FIELD OF THE INVENTION

The present invention relates to electric motors and more particularly, the present invention relates to electric motors especially suited for use in the borehole pumping and drilling art.

### BACKGROUND OF THE INVENTION

Motors for oil and gas wells are often long electric motors, and the stators for these rotors are correspondingly long. Motors of this type must be such as to meet the special space requirements of a borehole, so that the outside diameter is generally very limited, whereas such motors may be very long. The precise length depends on the desired power of the motor. Further to the special space requirements during operations in a downhole environment, this type of environment also represents challenging conditions such as high pressure, high temperature and an aggressive chemical environment.

The dielectric oil is also used to lubricate the rotor bearings, and provide a means to transmit the heat from the motor windings to the outside of the motor and in additional, provide electrical insulation for the motor windings.

However, the rotor cavity fluid can become contaminated with wellbore fluid, and once this occurs, the motor windings can be quickly degraded causing the eventual catastrophic destruction of the motor.

### SUMMARY OF THE INVENTION

According to the present invention, there is provided canned modular stator elements equal in length to a bearing span for the rotor and bearing supports for the modular stator elements to seal into to enable the rotor cavity to be sealed from the motor winding cavity.

According to the present invention, there is provided a means for making modular stator elements.

According to further aspect of the invention, stator modules are the length of a bearing span.

According to a further aspect of the invention, the bearings are supported in an insulated, ridged bearing support.

According to further aspect of the invention, the injection moulding material is an electrical insulation for the bearing support.

According to a further aspect of the invention the stator laminations are mounted on a monel alloy tube, which hermetically seals the stator module rotor bore from the winding cavity.

According to a further aspect of the invention extruded tubes of an electrical insulation material hermetically seal the stator motor winding slots from end to end.

According to a further aspect of the invention the stator modules can be stacked together and sealed by an o ring, to seal the rotor cavity from the motor winding cavity.

According to a further aspect of the invention the stators are aligned using the stator slot insulator.

According to a further aspect of the invention the bearing supports could be ceramic.

According to a further aspect of the invention the bearing supports are a hybrid construction using an inner and outer steel tube and an electrical insulated injection moulded material to hold together and provide winding slots for the motor windings.

According to a further aspect of the invention internal woodruff key ways are incorporated into the bearing supports to provide an anti-rotation feature for the outer bearing race of the rotor.

According to a further aspect of the invention, the bore of the rotor cavity is smooth.

According to a further aspect of the invention, the liner tube isolating the rotor cavity from the stator cavity is made from more than one monel tube so creates minimum impedance losses associated with a single steel canned tube.

According to a further aspect of the invention the motor housing provides a containment for potting the stator.

According to a further aspect of the invention, the stator is pressure compensated with its own dielectric fluid.

According to a further aspect of the invention the motor windings have a second independent electrical insulation barrier separate to the wire insulation enamel which isolates all phase to phase and phase to ground.

The advantage using injection moulding the manner described means the volumes in stot windings and elsewhere don't have to be pressure compensated. Also, the encapsulated modular structure makes it easier to handle.

The provision of the ceramic end wafers allows a convenient and precise guide for the winding end turning connections, ensuring that they are precisely and correctly located, insulated and tightly packed against vibration.

### BRIEF DESCRIPTION OF THE DRAWINGS

FIG. 1 shows an end view of a stator module

FIG. 2 shows a section side view of the stator shown in FIG. 1 with the elements to make a complete stator module.

FIG. 3 is a section side view of a modular bearing support

FIG. 4 is an isometric view of the three parts making up the bearing support shown in FIG. 3.

FIG. 5 is a section side view of three stator modules and four bearing supports, and the partial construction of the end turns.

FIG. 6 is an isometric view of one of the components used for motor winding end turn construction shown in FIG. 5.

FIG. 7 is an isometric view of one of the components used for motor winding end turn construction shown in FIG. 5.

FIG. 8 is an isometric view of the end turn assembly shown in FIG. 5.

FIG. 9 is a section side view of a fully assembled modular canned stator assembly.

FIG. 10 is a section side view of an empty motor housing assembly.

FIG. 11 is a section side view of a fully assembled modular canned stator assembly, installed inside the motor housing assembly.

FIG. 12 is the motor assemble shown in FIG. 11, being filled with potting material.

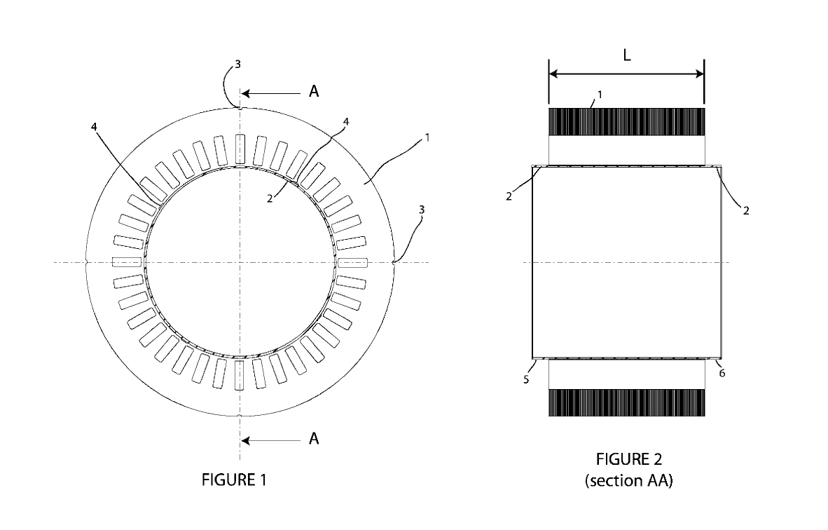

Referring to FIGS. 1 and 2 there is shown one embodiment of the invention.

A set of stator laminations 1 are arranged in a row and mounted onto a thin wall (0.5 mm) monel tube 2, the set laminations making a total length L (this length is typically dictated by the bearing span). A TIG or laser weld on the OD at 3 and at 4 on the OD of the monel tube and the lamination at each end of the stack of laminations holds the individual components together as a rigid assembly. The monel tube 2 extends 5, 6 beyond the set of laminations. These extending portions 5, 6 seals with the bearing support derived below.

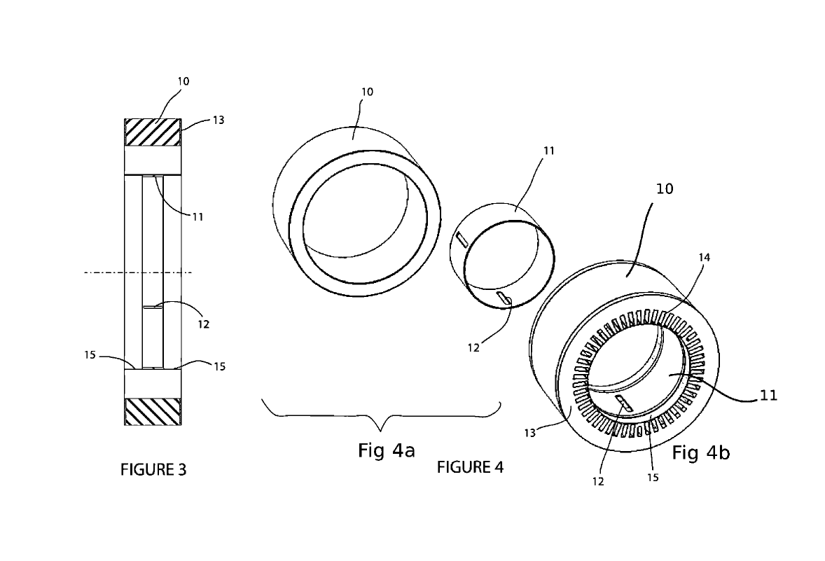

Referring to FIGS. 3 and 4 there is shown a hybrid bearing support. It consists of a outer steel spacer ring 10, an inner steel ring 11 with slots 12 which locate the rotor outer bearing race (in the manner of a woodruff key). Spacer ring 10, and inner ring 11 are put into an injection mould and a high temperature material 13 such as TF-60V, available from PBI Performance Products Inc. 9800-D Southern Pine Boulevard, Charlotte, N.C. 28273 is moulded between 10 and 11 to form a bearing support and have passages 14 for motor winding to pass through and recesses 15 for the modular stator to locate and seal into.

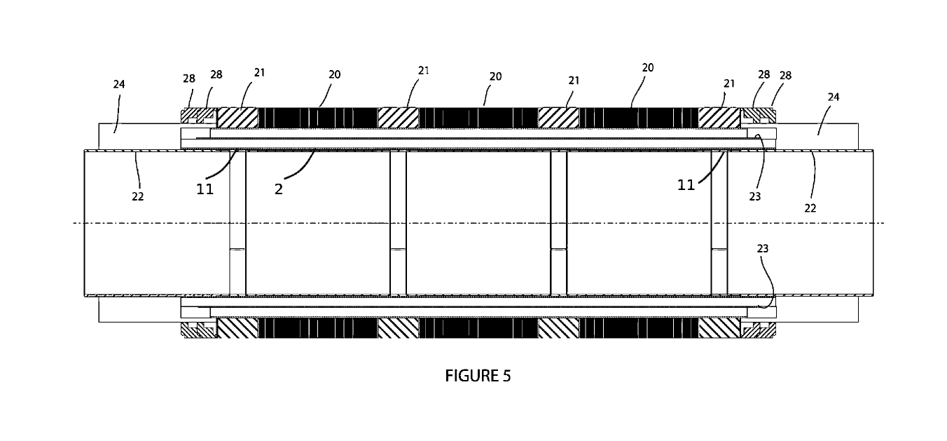

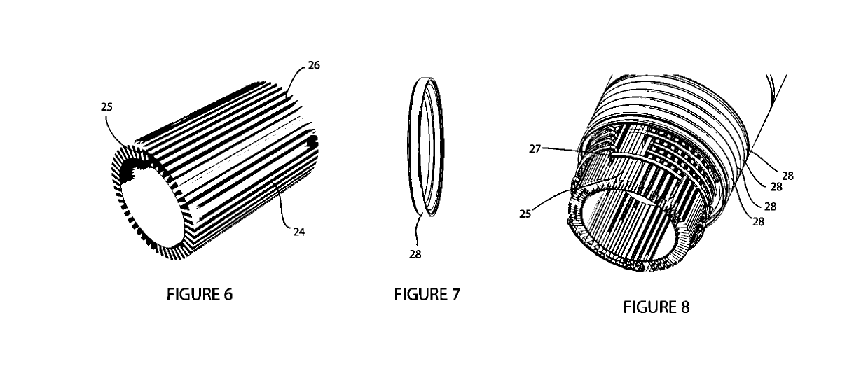

Referring to FIGS. 5 to 8 there is shown three stator modules 20 and four bearing supports 21 assembled. Two tubes 22 are fitted at each end abutting the inner rings 11, to extend the canned stator assembly so the end turn windings will be fully isolated from the rotor cavity (the motor windings are not shown here for clarity, but are shown in FIG. 8). A circularly arranged array of slot electrical insulation tubes 23 are included in the stator assembly, which run through the entire length of the motor (passing through the laminations slots 8 and the bearing support passages 14) and terminate inside the extruded assembly. This extruded assembly, has the same geometric slot arrangement 25 as shown in the motor lamination 1 in FIG. 1, all the slots are open 26 at the ends of the stator assembly, and the motor winding, as it exits the slot insulation tube 23 bends to run parallel to the outer surface of 24 before being feed back into the return slot 27. An electrically insulated cover 28 is placed over the wire of the winding where it exits the lamination stack, and fully encases it.

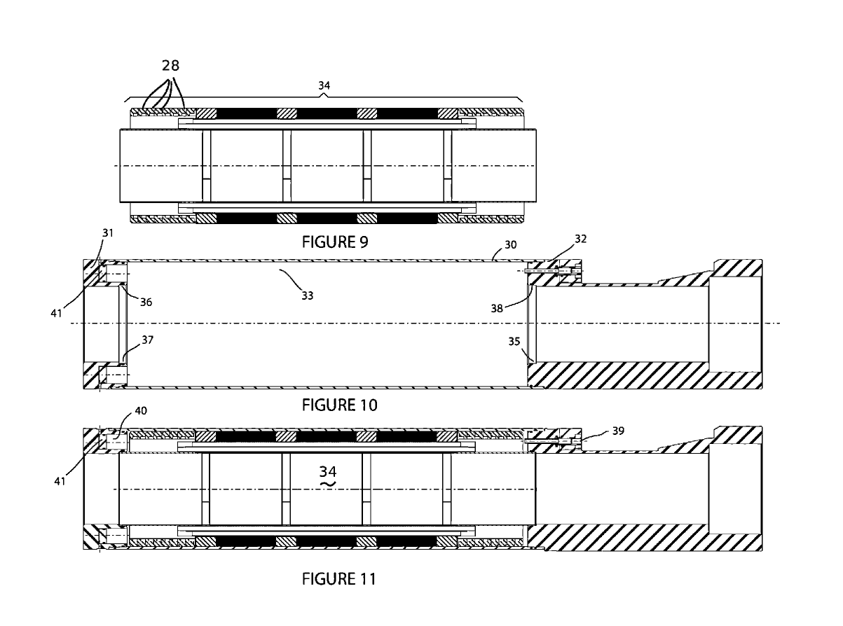

The winding turns occur at different spacings from the end of the stator lamination stack, and each cover interlocks with the previous, early fitted one. Some of the cover plates have been removed in FIG. 8 to show how the motor windings are arranged. FIG. 9 shows a fully assembled modular stator, with a complete end turn arrangement (not shown) encased with cover plates 28. It will be appreciated that all three phases are wound at the same time.

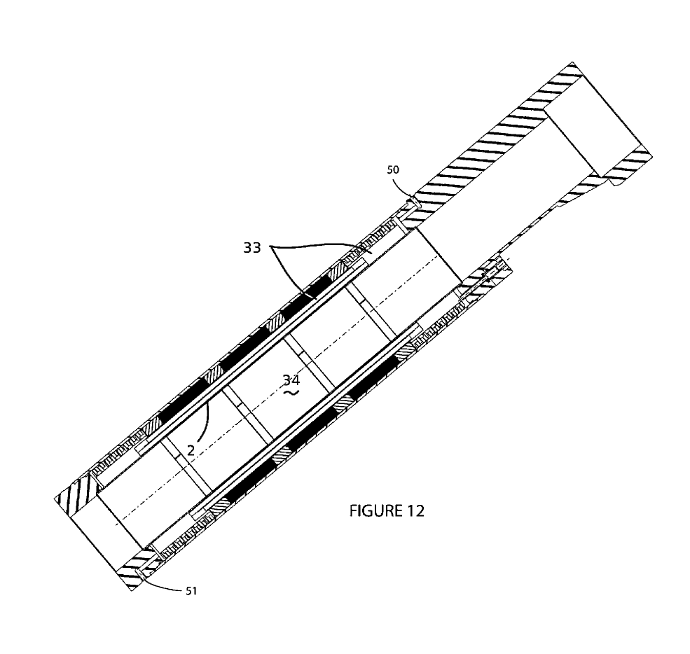

Referring to FIGS. 9 to 11 there is shown a motor housing 30 with end caps 31 and 32. The cavity 33 is where the modular canned stator 34 will locate. Once installed inside the cavity 33 the canned motor module 34 abuts against the bores 35 and 36, against O rings 37 and 38 forming a seal. The motor windings are terminated at connections 39. The void space 40 is completely filled with dielectric oil. Compensating piston 41 ensures the pressure inside the stator cavity is equal to the pressure outside the motor. A pressure relief value (not shown) is included to allow for the initial thermal expansion of the dielectric oil. The rotor cavity is therefore fully isolated from the stator cavity.

Referring to FIG. 12, it may be desirable to fully encapsulate the voids of the stator cavity 33 outside the sealed tube formed by the stator tubes 2 and bearing support tubes 11. This is achieved by arranging for the motor be vertical or near vertical, and apply a vacuum via the port 50 and inject a low viscosity potting material via port 51. The volume of potting material is carefully monitored, and once the stator cavity is full both ports 50 and 51 can be plugged.

External and internal features described here as provided by machining could equally be provided by injection molding to that shape, and equally, features described here as being provided by the injection molding could instead be machined.

What is claimed is:

1. A stacked stator comprising a plurality of modular components including modular stator elements canned in a cylindrical wall, each modular stator being substantially equal in length to a bearing span for the rotor, and a thin wall longitudinal tube which seals the rotor cavity, wherein each modular component abuts the modular component to seal the rotor cavity.

2. A stacked stator according to claim 1, wherein the modular components including modular bearing supports.

3. A stacked stator according to claim 1, wherein longitudinal winding slots are provided, having insulating slot liners.

4. A stacked stator according to claim 3, wherein the insulating slot liners are extruded.

5. A stacked stator according to claim 2, wherein the bearings are supported in an insulated, ridged bearing support.

6. A stacked stator according to claim 5, wherein the injection moulding material is an electrical insulation for the bearing support.

7. A stacked stator according to claim 1, wherein stator laminations are mounted on a monel alloy tube, which hermetically seals the stator module rotor bore from the winding cavity.

8. A stacked stator according to claim 1, wherein the stator modules are sealed by an o ring, to seal the rotor cavity from the motor winding cavity.

9. A stacked stator according to claim 1, wherein the stators are aligned using a stator slot insulator.

10. A stacked stator according to claim 2, wherein the bearing supports are be ceramic.

11. A stacked stator according to claim 2, wherein the bearing supports are a hybrid construction using an inner and outer steel tube and an electrical insulated injection moulded material to hold together and provide winding slots for the motor windings.

12. A stacked stator according to claim 2, wherein internal woodruff key ways are incorporated into the bearing supports to provide an anti-rotation feature for the outer bearing race of the rotor.

13. A stacked stator according to claim 1, wherein the bore of the rotor cavity is smooth.

14. A stacked stator according to claim 1, wherein the tube isolating the rotor cavity from the stator cavity is made from more than one monel tube to create minimum impedance losses associated with a single steel canned tube.

15. A stacked stator according to claim 1, wherein a motor housing provides a containment for potting the stator.

16. A stacked stator according to claim 1, wherein the stator is pressure compensated with its own dielectric fluid.

17. A stacked stator according to claim 1, wherein the motor windings have a second independent electrical insulation barrier separate to the wire insulation enamel which isolates all phase to phase and phase to ground at the end turn.

18. A stacked stator according to claim 1, wherein circular wafer supports are provided at each end of the stator stack, which define a precise path for the end turns of the windings

19. A stacked stator according to claim 16, wherein the circular wafer supports interlock, and prevent tracking to the outer housing.
